(19) United States
(12) Patent Application Publication
(10) Pub. No.: US 2015/0218717 A1
(43) Pub. Date: Aug. 6, 2015

(54) PRODUCTION OF FORMATE FROM CARBON DIOXIDE WITH IMMOBILIZED IRIDIUM PINCER COMPLEX CATALYSTS

(71) Applicant: The University of North Carolina at Chapel Hill, Chapel Hill, NC (US)

(72) Inventors: Peng Kang, Durham, NC (US); Maurice Brookhart, Carrboro, NC (US); Thomas Meyer, Chapel Hill, NC (US); Sheng Zhang, Chapel Hill, NC (US)

(21) Appl. No.: 14/608,652

(22) Filed: Jan. 29, 2015

Related U.S. Application Data
(60) Provisional application No. 61/934,226, filed on Jan. 31, 2014.

(51) Int. Cl. C25B 3/04; C25B 11/04; C07F 15/00

(52) U.S. Cl. CPC C25B 3/04; C07F 15/0033; C25B 11/0405; C25B 11/0489

(57) ABSTRACT

Catalytic compounds, catalytic electrodes comprising such compounds useful for generating formate from carbon dioxide, and methods of regenerating such electrodes are described. The catalytic compounds are in general compounds of Formula (I) or Formula (II):

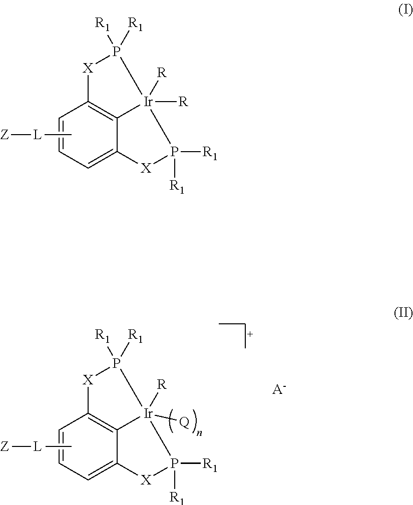

wherein: each R is independently H or a C₁-C₃₀ hydrocarbyl radical; each R₁ is independently a C₁-C₃₀ hydrocarbyl radical; each X is independently selected from O and CH₂; L is a covalent bond or linking group; Z is an at least one planar pi-bond containing organic group; each Q is a neutral two-electron donor ligand; n is 1 or 2; and A⁻ is a non-coordinating counter-anion.

### RELATED APPLICATIONS

This application claims the benefit of U.S. Provisional Patent Application Ser. No. 61/934,226, filed Jan. 31, 2014, the disclosure of which is incorporated by reference herein in its entirety.

### STATEMENT OF FEDERAL SUPPORT

This invention was made with Government support under Grant No. DE-SC0001011 awarded by the Department of Energy. The United States Government has certain rights to this invention.

### FIELD OF THE INVENTION

The present invention concerns compounds, electrode constructs, and methods of making and using electrodes for the catalytic reduction of carbon dioxide to formate.

### BACKGROUND OF THE INVENTION

Utilizing electricity generated from renewables to reduce CO₂ to fuels and chemicals has attracted considerable attention as petroleum reserves dwindle.^{[1]} Formic acid and formate are two-electron reduced products of CO₂ and can serve as hydrogen storage materials^{[2]} as precursors to methanol,^{[3]} as reducing agents in organic synthesis,^{[4]} as fuels for fuel cells,^{[5]} as an environmentally attractive substitute for mineral acids widely used in applications in mining, drilling and hydrofracking,^{[6]} and as a feedstock for bacteria in the production of gasoline substitutes.^{[7]} Currently, formic acid is produced by an inefficient multi-step process.^{[6a]} Development of an efficient single-step, electrocatalytic method for formate/formic acid production could reduce the cost^{[8]} and enhance their attractiveness for use as a fuel and for other applications.

Critical to large-scale electrochemical formate production is the development of high performance CO₂ electrolyzers equipped with efficient, selective, and robust CO₂ reduction catalysts. Organometallic catalysts^{[9]} can reduce CO₂ to formate^{[10]} or CO^{[11]} with high selectivity and efficiency and represent a major class of CO₂ reduction catalysts as are solid metallic electrodes.^{[12]} Nonetheless, reports of electrochemical reduction of CO₂ by supported organometallic catalysts remains limited,^{[13]} and this limitation poses a major challenge in using this versatile family of catalysts on large scales in electrochemical and photoelectrochemical applications.

### SUMMARY OF THE INVENTION

A first aspect of the invention is a catalytic compound of Formula I or Formula II:

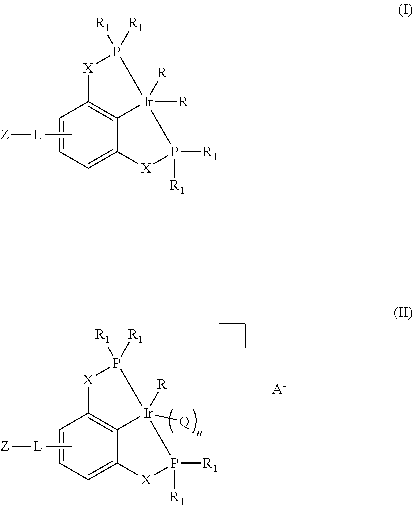

wherein:

each R is independently H or a C₁-C₃₀ hydrocarbyl radical;

each R₁ is independently a C₁-C₃₀ hydrocarbyl radical;

each X is independently selected from O and CH₂;

L is a covalent bond or any suitable linking group;

Z is a binding group, such as an at least one planar pi-bond containing organic group;

each Q is a neutral two-electron donor ligand,

n is 1 or 2; and

A⁻ is a non-coordinating counter-anion.

A further aspect of the invention is a method of making or regenerating a catalytic electrode useful for the production of formate from carbon dioxide, comprising:

(a) providing a gas diffusion electrode having a electrolyte contact surface, carbon nanoparticles on said electrolyte contact surface, and optionally a polyalkylene oxide coating on said carbon nanotubes;

(b) contacting to said carbon nanoparticles a polar organic solvent having a catalytic compound as described herein under conditions in which said catalytic compound conjugates to said nanotubes; and
(c) optionally coating or recoating said nanotubes with an organic polymer before or after said contacting step.

In some embodiments, the carbon nanoparticles are comprised of an sp2-carbon containing material; and/or the organic polymer comprises a hydrophilic or amphiphilic, neutrally, cationically or anionically charged, organic polymer.

A further aspect of the invention is a catalytic electrode useful for the production of formate from carbon dioxide, comprising: (a) an electrode substrate having a electrolyte contact surface; (b) carbon nanoparticles on said electrolyte contact surface; (c) a catalytic compound as described herein coupled to the carbon nanotubes; and (d) an organic polymer coating on said carbon nanotubes.

In some embodiments, the electrode substrate comprises a porous carbon gas diffusion electrode.

In some embodiments, the carbon nanoparticles are comprised of an sp2-carbon containing material, examples of which include but are not limited to carbon nanotubes (including both single walled and multi walled carbon nanotubes), graphene, graphene oxide, fullerenes (including C60 and C70 fullerenes), etc., including combinations thereof.

In some embodiments, the polymer coating comprises a hydrophilic or amphiphilic, preferably neutrally charged, organic polymer, examples of which include but are not limited to polyethene glycol (PEG), PEG-polystyrene copolymers, polyvinylpyrrolidone, polyvinyl alcohols, etc., including combinations thereof.

In some embodiments, the carbon nanoparticles are deposited on the electrode substrate to a thickness of 0.1 micrometers to 200 micrometers; and/or said polymer coating is loaded on the carbon nanotube layer to a weight of 0.001 milligrams per square centimeter up to 20 milligrams per square centimeter.

A further aspect of the invention is a method of making formate from carbon dioxide, comprising: providing a catalytic electrode as described herein; and contacting said electrode to water and carbon dioxide while passing a current through said electrode sufficient to reduce said carbon dioxide to formate.

The foregoing and other objects and aspects of the present invention are explained in greater detail in the drawings herein and the specification set forth below.

### BRIEF DESCRIPTION OF THE DRAWINGS

FIG. 1. Non-covalent immobilization of the Ir pincer dihydride catalyst 1 on a carbon nanotube electrode for electrochemical reduction of CO₂ to formate.

FIG. 2. Fabrication of Ir catalyst-loaded carbon nanotube electrodes (FTO: fluorine doped tin oxide. GDL: gas diffusion layer. See experimental for details).

FIG. 3. SEM images of CNT thin films on FTO (a, b) and ODL (c, d). Left column: cross section. Right column: top down. (Scale bar: 1 μm)

FIG. 4. Cyclic voltammograms (CVs) of a GC/CNT/1/PEG electrode in water. Left: CVs under Ar (blue) and 1 atm CO₂ (red) at 100 mV/s scan rate. Right: CVs of 50 successive cycles at 200 mV/s scan rate under CO₂. Conditions: 0.1 M NaHCO₃, 0.5 M LiClO₃, 1% v/v MeCN, electrode surface area 0.07 cm², room temperature.

FIG. 5. Left: Controlled potential electrolyses with GC/CNT/1/PEG (blue, entry 3 in Table 1) and GC/CNT/1 (red, entry 6 in Table 1) electrodes in water under CO₂. Right: catalyst surface loading on GC/CNT/1/PEG vs. the number of the catalyst replenishment.

FIG. 6. Proposed mechanism for interfacial reduction of CO₂ to formate.

### DETAILED DESCRIPTION OF THE PREFERRED EMBODIMENTS

The present invention is explained in greater detail below. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which does not depart from the instant invention. Hence, the following specification is intended to illustrate some particular embodiments of the invention, and not to exhaustively specify all permutations, combinations and variations thereof.

The disclosures of all United States patents cited herein are to be incorporated herein by reference in their entirety.

### 1. Catalytic Compounds.

As noted above, the catalyst is an iridium pincer complex catalyst, such as described in U.S. Pat. No. 8,362,312 to Brookhart et al. and U.S. Pat. No. 6,982,305 to Nagy, covalently coupled to a binding group, such as described in US Patent Application No. US 2010/0038597 to Reynolds, Walczak and Rinzler. Examples of such catalysts include but are not limited to compounds of Formula (I) and Formula (II):

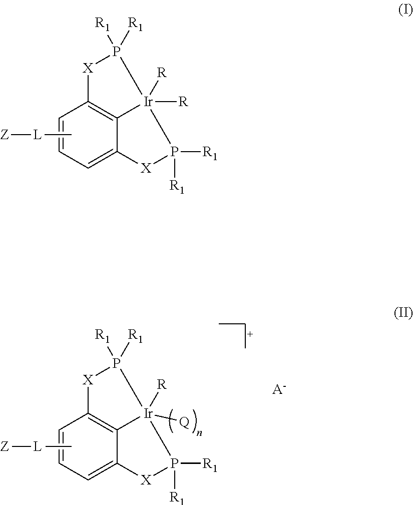

wherein:

each R is independently H or a C₁-C₃₀ hydrocarbyl radical;
each R₁ is independently a C₁-C₃₀ hydrocarbyl radical;
each X is independently selected from 0 and CH₂;

L is a covalent bond or any suitable linking group (including aromatic, aliphatic and mixed aromatic and aliphatic linking groups); and

Z is a binding group, such as an at least one planar pi-bond containing organic group;

each Q is a neutral two-electron donor ligand, examples of which include but are not limited to nitriles (e.g., acetonitrile, propionitrile, benzonitrile, etc.), ethers (e.g., dimethyl ether, diethyl ether, tetrahydrofuran, etc.), alcohols and other polar and non-polar organic solvents (e.g., benzene, toluene, methylene chloride, acetone, methanol, ethanol, pyridine, etc.), water, etc.;
n is 1 or 2; and

A⁻ is a non-coordinating counter-anion, examples of which include but are not limited to PF₆⁻, BF₄⁻, RSO₃⁻, BAr₄⁻

In some embodiments, the planar organic group comprises a polycyclic aromatic group, examples of which include but are not limited to pyrene, anthracene, pentacene, benzo[a]pyrene, chrysene, coronene, corannulene, naphthacene, phenanthrene, triphenylene, ovalene, benzophenanthrene, perylene, benzo[ghi]perylene, antanthrene, pentaphene, picene, dibenzo[3,4;9,10]pyrene, benzo[3,4]pyrene, dibenzo[3,4;8,9]pyrene, dibenzo[3,4;6,7]pyrene, dibenzo[1,2;3,4]pyrene, naphto[2,3;3,4]pyrene, and combinations thereof. In some embodiments, the polycyclic aromatic group contains at least one heteroatom (e.g., 1, 2, 3 or 4 heteroatoms, or more) such as O, S, N, P, B, Si, and combinations thereof. In some embodiments, the polycyclic aromatic group comprises a graphene sheet. See, e.g., US Patent App. No. US 2010/0038597 to Reynolds et al.

“Linking groups” as used herein are generally bivalent aromatic, aliphatic, or mixed aromatic and aliphatic groups. Thus linking groups include linear or branched, substituted or unsubstituted aryl, alkyl, alkylaryl, or alkylarylalkyl linking groups, where the alkyl groups are saturated or unsaturated, and where the alkyl and aryl groups optionally containing independently selected heteroatoms such as 1, 2, 3 or 4 heteroatoms selected from the group consisting of N, O, and S. In some embodiments, linking groups containing from 2 to 20 carbon atoms are preferred. Numerous examples of suitable linking groups are known, including but not limited to those described in, U.S. Pat. Nos. 8,247,572; 8,097,609; 6,624,317; 6,613,345; 6,596,935; and 6,420,377, the disclosures of which are incorporated by reference herein in their entirety.

### 2. Catalytic Electrodes and Methods of Making/Regenerating the Same.

A method of making an electrode of the present invention (or regenerating such an electrode, e.g., when catalyst loading and/or activity thereon has declined) may be carried out by: (a) providing an electrode substrate (e.g., a gas diffusion electrode such as a carbon based gas diffusion electrode) having an electrolyte contact surface, carbon nanotubes on that electrolyte contact surface, and optionally a polyalkylene oxide coating on the carbon nanotubes; (b) contacting to those nanotubes a solvent having a catalytic compound as described above under conditions in which that catalytic compound conjugates to said nanotubes; and (c) optionally coating or recoating those nanotubes with a polymer layer such as a polyalkylene oxide before or after the contacting step.

While any suitable electrode substrate may be used, in some embodiments a gas diffusion electrode, is used. Such electrodes are known and suitable examples include, but are not limited to, those described in U.S. Pat. Nos. 7,666,812; 6,503,655; 6,361,666; and in R. Paxton et al., Porous Carbon Gas Diffusion Electrodes, J. Electrochem. Soc. 110, 932-938 (1963).

In some embodiments, the electrode comprises a current collector and a gas diffusion layer (which may serve as an electrolyte contact surface), with the carbon nanomaterials deposited on the gas diffusion layer. The current collector may comprise any suitable electrically conductive material, including but not limited to carbon fiber, carbon cloth, carbon paper, carbon felt, carbon mesh, reticulated vitreous carbon, graphite, etc. The gas diffusion layer may comprise any suitable electrically conductive, gas permeable material, generally in porous form, including but not limited to carbon blacks (such as Ketj en Black EC 300 J, Vulcan XC-72 and Black Pearl 2000), PTFE or PVDF-modified carbon black, carbon soot, amorphous carbon particles, etc.

The carbon nanomaterials are comprised of an sp2-carbon containing material, examples of which include but are not limited to carbon nanotubes (including both single walled and multi walled carbon nanotubes), graphene, graphene oxide, fullerenes (including C60 and C70 fullerenes), etc., including combinations or derivatives thereof.

The carbon nanomaterials may be deposited on the electrode substrate by any suitable technique (such as dip coating, spin coating, spray coating, etc), generally to a thickness of 0.1, 0.2 or 1 micrometers, up to 50, 100 or 200 micrometers, or more.

Solvents employed in the method described above generally comprise organic solvents, including polar solvents and polar aprotic solvents such as nitrile solvents. Suitable examples include, but are not limited to, acetonitrile, propionitrile, benzonitrile, etc.

The catalyst may be loaded on the electrode substrate in any suitable amount, typically, from 0.0001 or 0.001 milligrams per square centimeter, up to 0.01, 0.1 or 1 milligrams per square centimeter, or more.

The polymer coating may comprise a hydrophilic or amphiphilic, preferably neutrally charged, organic polymer, examples of which include but are not limited to polyethene glycol (PEG), PEG-polystyrene copolymers, polyvinylpyrrolidone, polyvinyl alcohols, etc., including combinations thereof.

The polymer coating may be loaded on the carbon nanomaterials layer by any suitable technique, including dip coating, spray coating, spin coating, and ink printing, etc. and may be loaded to a weight of 0.001 or 0.01 milligrams per square centimeter, up to 5, 10 or 20 milligrams per square centimeter, or more.

Conditions for contacting and coating are not critical and may be room or ambient temperature, or elevated or decreased temperatures, for any suitable time, depending on the particular coating or contacting technique employed.

3. Production of formate and formic acid.

In a non-limiting embodiment the electrode is used in the configuration of “gas stream/electrode/electrolyte,” with the current collector side contacting the gas stream and the polymer side contacting with electrolyte. The gas stream may be dry CO₂, humidified CO₂, or CO₂/inert gas (N₂, Ar, He etc) mixtures. The electrolyte may be a liquid aqueous electrolyte using bicarbonates, carbonates, perchlorates, sulfates, phosphates and similar electrolytes of suitable concentrations (0.01˜10 M) etc., or a solid electrolyte membrane such as Nafion, polystyrene sulfonate, poly[2,2′(m-phenylene)-5,5′bibenzimidazole, or other forms of cation exchange or anion exchange membranes.

While the reaction product has been referred to as formate above, which is the anion of formic acid, the formate is provided in aqueous solution by the methods described herein resulting in the production of formic acid.

Commercial Utility.

Formic acid is useful as a preservative and antibacterial agent in livestock feed, for example by application to such feed (including fresh hay) to promote the fermentation of lactic acid and to suppress the formation of butyric acid), as a constituent of leather tanning processes, for dyeing and finishing textile materials, as a coagulant in the production of rubber, as a cleaner such as a limescale remover, as a de-icing agent for road and airport runways, as a major ingredient for drilling and completion fluids, as an intermediate for the production of artificial flavors or perfumes, as a miticide by beekepers, as a fuel cell constituent, etc.

### EXAMPLES

Design inspiration comes from the integration of solid metal catalysts in fuel cells and water electrolyzers. A key element in such devices is use of the catalyst-loaded gas diffusion electrode (GDE).^{[14]} GDEs can improve mass transport across the gas-liquid interface, yielding considerably higher current densities than plate electrodes.^{[12c, 15]} Utilization of the GDE configuration with integrated, surface-bound organometallic CO₂ reduction catalysts could greatly accelerate the translation process in the application of organometallic catalysts and provide guidelines for developing practical electrolyzers.

Two major approaches have been used for the functionalization of carbon surfaces with functional molecules. Covalent immobilization methods^{[13b,16]} use chemical bonds as linkers, but require synthetic modifications of the catalyst(s) that can be complex and require special pretreatment of the carbon surface which may be non-trivial, mitigating viability for large-scale applications. A disadvantage of this method is that catalyst decay generally necessitates electrode replacement. It is economically more attractive to be able to re-functionalize the electrodes without decommissioning since the electrodes constitute a significant portion of electrolyzer cost.

Non-covalent surface binding methods using strong van der Waals π-π interactions between polyaromatic hydrocarbons and graphitized carbon surfaces offering a convenient, non-destructive approach to catalyst immobilization with excellent surface stability.^{[16a]} The conjugated sp² structure of graphite is also preserved which maintains the high conductivity of the carbon substrate. This technique has been used to surface-bind water oxidation,^{[17}] proton reduction catalysts,^{[18]} and recently CO₂ reduction catalysts to produce CO.^{[19]} It has not yet been applied to electrocatalytic CO₂ reduction catalysts to produce formate and we report a dramatic example here in terms of rate, turnover number, surface stability and applicability.

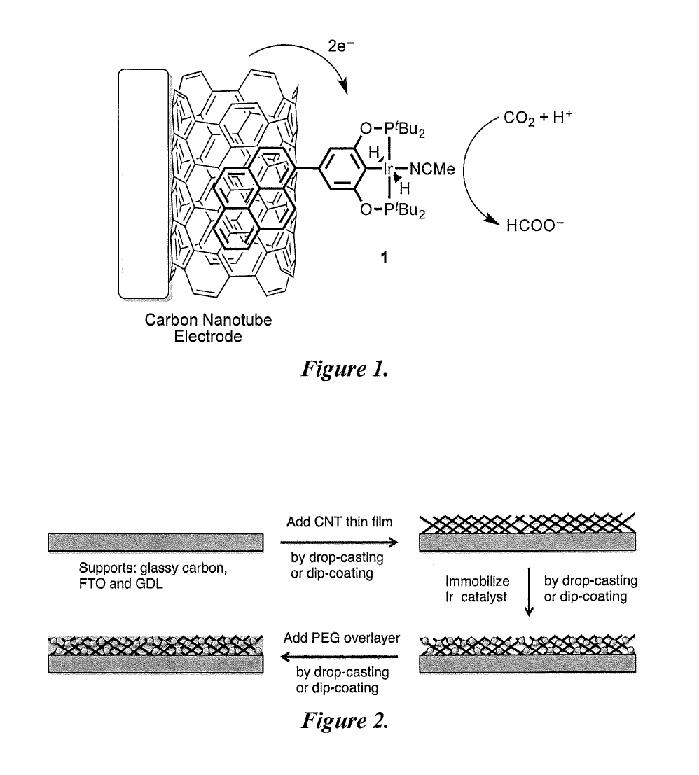

We previously reported homogeneous electrochemical reduction of CO₂ to formate in both non-aqueous and aqueous media with Ir pincer dihydride complexes.^{[10d, 10e]} The Ir catalysts are efficient and selective in generating formate without catalyzing the formation of CO from CO₂ and H₂ from water. Here we immobilize a pyrene-modified Ir pincer dihydride complex, 1, onto large surface-area, multi-walled carbon nanotube (CNT) electrodes (FIG. 1), and apply this method to fabricate GDEs for electrochemical reduction of CO₂ to formate with impressive rates and turnover numbers.

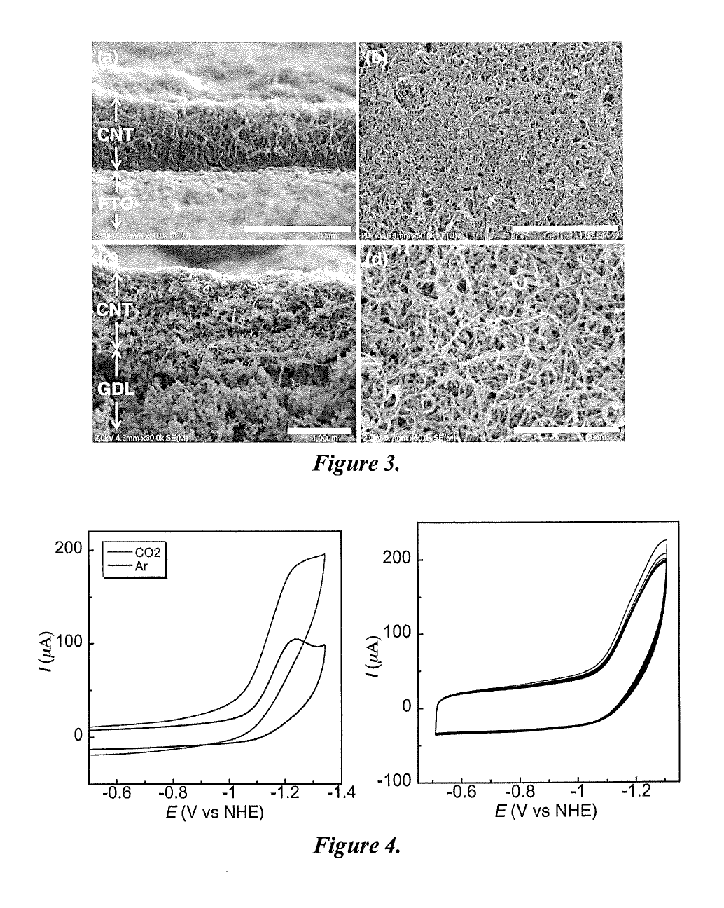

Nanostructured electrodes were prepared as described in FIG. 2. The CNTs were ultrasonically dispersed in DMF (1 mg/mL) without use of a surfactant. Support electrodes, glassy carbon (GC) or fluorine doped tin oxide (FTO), were drop-cast with the CNT suspension (ca. 0.03 mg/cm² coverage). The morphology of the deposited CNT thin film on FTO was shown by scanning electron microscopy (SEM) to be a highly porous nanostructure, FIG. 3 (a, b). No bare FTO surface was observed. The average film thickness was measured as 500-700 nm and the pore size between 20-100 nm. The electro-active surface area of an as-made GC/CNT electrode was evaluated by cyclic voltammetry (CV) with K₄[Fe(CN)₆] as a probe. The measured surface area was ca. 5 times higher than the bare GC electrode (FIG. S2). The high porosity and increased surface area provide a basis for achieving high current densities in CO₂ electrolyses.

Ir pincer dihydride complex 1 (FIG. 1) was immobilized by drop-casting a MeCN solution (0.2 mM) on CNT coated GC or FTO electrodes under Ar (FIG. 2). X-ray photoelectron spectroscopy (XPS) of the FTO/CNT/1 electrode exhibited Ir 4f_{5/2} and 4f_{7/2} peaks at 62.1 and 64.5 eV and a P 2p peak at 132.3 eV with an Ir:P ratio of ca. 1:1.8 (data not shown). A poly-ethylene glycol (PEG) overlayer (ca. 3 μg/cm²) was subsequently applied by drop-casting 0.01% w/w aq. solution onto the GC/CNT/1 electrode. The PEG overlayer does not affect the electro-active surface area significantly but improves the mechanical stability of the electrode.

The response of the GC/CNT/1/PEG electrode under Ar in water (0.1 M NaHCO₃, 0.5 M LiClO₄, 1% MeCN v/v) was probed by cyclic voltammetry (CV). A reduction wave with peak potential at E_{p,c}=−1.25 V vs NHE was observed (FIG. 4, left) along with oxidation waves with peak potentials at E_{p,a}=0.15 and 0.30 V on a reverse scan (data not shown). Consistent with previous studies in solution,^{[10e]} the reduction wave arises from formation of 1 by 2e⁻/1H⁺ reduction, and the oxidation waves from re-oxidation of 1 by 2e⁻/1H⁺ to cation 2 (FIG. 6). Variations in peak current (i_{p,c}) for the reduction wave at E_{p,c}=−1.25 V are proportional to the scan rate ν, characteristic of a redox response from a surface-immobilized redox entity (eq.1, data not shown).

i_{p,c}=(n²F²νAΓ)/(4RT) (1)

In eq. 1, Γ is the surface coverage (mol/cm²), Q is the charge under the surface wave (C), ν the scan rate, F the Faradaic constant, A the electrode area (cm²) and n is the number of electrons transferred. The surface coverage was calculated from eq. 2 with charge Q obtained by integration of the reduction wave. With n=2,^{[10e]} a typical coverage on a GC/CNT electrode was calculated to be Γ=2.2×10⁻⁹ mol/cm².

Γ=Q/nFA (2)

Under 1 atm of CO₂, the reduction wave at E_{p,c}=−1.2 V was catalytically enhanced with an onset at ca. −1.0 V (FIG. 4, left). Current enhancements of ca. 2 fold were observed at a scan rate of 100 mV/s. Between scan rates from 100 to 500 mV/s, catalytic currents were no longer linearly variant with the scan rates (data not shown), suggesting that the rate of electrocatalysis is largely dictated by a rate-limiting chemical step. In this limit, the catalytic current, i_{cat}, is related to the catalytic rate constant, k_{cat}, or turnover frequency as shown in equation 3. Using n_{cat}=2 for formate production, k_{cat} was calculated as 6.7 s⁻¹. This value is comparable to k_{cat} of 7.3 s⁻¹ for the related water-soluble Ir pincer catalyst reported earlier.^{[10e]}

i_{cat}=n_{cat}FAΓk_{cat} (3)

The Ir pincer catalyst demonstrates high surface stability under catalytic conditions. The derivatized surface retained its electrochemical response after soaking in water under Ar for a day. The catalytic current under CO₂ was cycled for 50 times with less than 10% drop in current (FIG. 4, right). The surface stability in this case arises predominately from π-π interactions between the pyrene linker and the CNT surface. The π-π interaction between a single pyrene and sp² carbon surfaces has been estimated as 9.1 kcal/mol.^{[20]} Additional surface stability is derived from the four text-butyl groups of the catalyst rendering it highly hydrophobic and insoluble in water. The two factors combine to create a high degree of surface CNT stability even without a covalent linker.

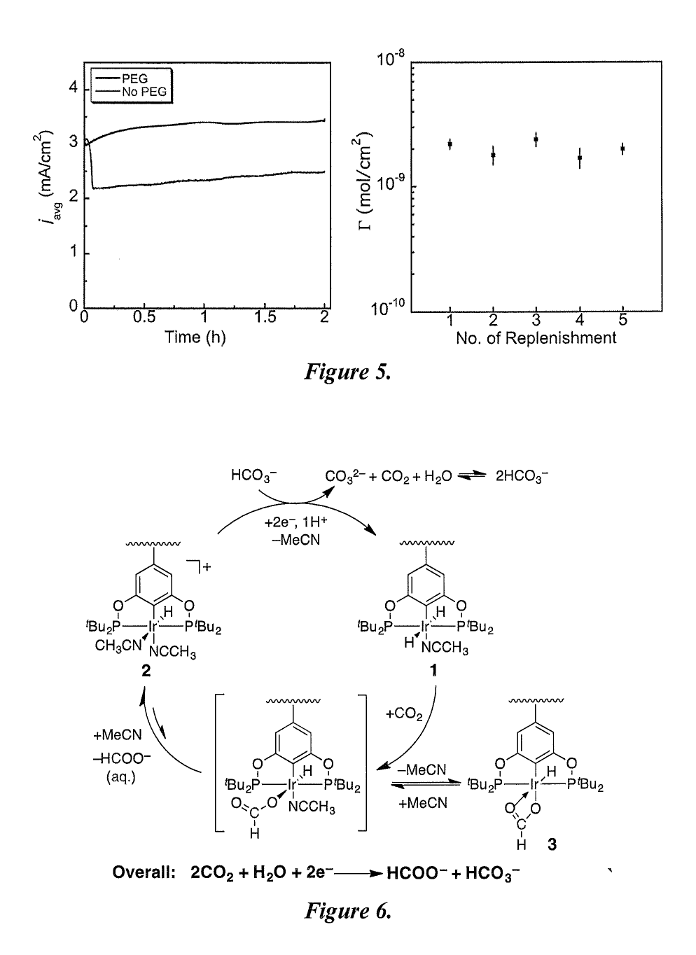

Long-term electrolyses were performed in aqueous media under a variety of conditions (Table 1). Using GC/CNT/1/PEG electrodes, entries 1-3, the currents were sustained during the electrolyses (FIG. 5, Left) with current densities from 1-3.3 mA/cm². Faradaic efficiencies for formate production were generally above 90% and up to 96% as shown in entry 1. The only product in the headspace was H₂ with no CO observed by GC analyses. Decreasing the applied potential from −1.2 V to −1.3 and −1.4 V (entries 1-3, Table 1) increases the current density from 1 to 3.3 mA/cm² and also slightly increases H₂ formation. In the absence of the Jr catalyst, entry 5, the GC/CNT/PEG electrode generates predominantly H₂ (90%). This observation points to H₂ production in entries 1-3 as a background reaction at the CNT electrode.

The efficiency of the hybrid surface catalytic system is remarkable. The maximum turnover frequency (TOF) under 1 atm of CO₂ based on formate production was 7.4 s⁻¹ as shown in entry 3, Table 1. This value is comparable to kₐₜ derived from the CV experiments. High catalyst stability yields high turnover numbers (TON). For example, electrolysis over an 8 hour period (entry 4, Table 1) leads to formate production to a level of ca. 11 mM in water with a TON of 203,000, highlighting the high efficiency and longevity of this system.

Sustained catalysis requires addition of small amount of MeCN and the PEG overlayer. Addition of 1% MeCN stabilizes cationic species 2 as noted in the earlier study in water.^{[10e]} The PEG overlayer is critical for stabilizing the catalytic interface. Without this overlayer, entry 6 in Table 1, the catalytic current dropped during the initial 5 minutes of the electrolysis to ca. 60% of the initial current density (FIG. 5, left). A CV showed a new, single oxidation wave at E_{p,a}=0.40 V vs NHE (data not shown), consistent with the oxidation wave for the authentic neutral formate complex 3 (data not shown) in FIG. 6 which was not observed with the added PEG overlayer. Sustained catalysis requires water for formate dissociation and solvation and regeneration of 2, as shown in FIG. 6.

TABLE 1
Conditions for Controlled Potential Electrolysis^{[a]} and Product Analyses.

| | | | j_{avg} | | HCOO⁻ | | HCOO⁻ | H₂ | CO |
|---|---|---|---|---|---|---|---|---|---|
| | | E (V vs | (mA | Time | Yield | HCOO⁻ | TOF | Yield | Yield |
| Entry | Cathode | NHE) | cm⁻²) | (h) | (%)^{[b]} | TON | (s⁻¹) | (%)^{[c]} | (%) |
| 1 | GC/CNT/1/PEG^{[d]} | −1.2 | 1.0 | 2 | 96 | 16,000 | 2.3 | 3 | n.o.^{[e]} |
| 2 | GC/CNT/1/PEG^{[d]} | −1.3 | 2.2 | 2 | 94 | 35,000 | 4.9 | 4 | n.o.^{[e]} |
| 3 | GC/CNT/1/PEG^{[d]} | −1.4 | 3.3 | 2 | 93 | 53,000 | 7.4 | 7 | n.o.^{[e]} |
| 4 | GC/CNT/1/PEG^{[d]} | −1.4 | 3.6 | 8 | 83 | 203,000 | 7.0 | 12 | n.o.^{[e]} |
| 5 | GC/CNT/PEG^{[d]} | −1.4 | 1.7 | 2 | 5 | 1,500 | 0.2 | 90 | 2 |
| 6 | GC/CNT/1^{[d]} | −1.4 | 2.3 | 2 | 89 | 33,000 | 4.6 | 10 | n.o.^{[e]} |
| 7 | GDL/CNT/1/PEG^{[f]} | −1.4 | 6.9 | 2 | 86 | 50,000 | 7.0 | 10 | n.o.^{[e]} |
| 8 | GDL/CNT/1/PEG^{[f][g]} | −1.4 | 10.2 | 2 | 82 | 71,000 | 9.8 | [h] | [h] |

^{[a]}Conditions: 0.5M LiClO₄, 0.1 NaHCO₃, 1% v/v MeCN, 1 atm CO₂, SCE reference electrode, Pt mesh counter electrode,
^{[b]}Analyzed by ¹H-NMR.
^{[c]}Analyzed by gaseous GC.
^{[d]}Surface area = 0.07 cm².
^{[e]}Not observed.
^{[f]}Surface area = 0.5 cm².
^{[g]}CO₂ purged through catholyte.
[h] Gaseous product not determined due to CO₂ purging.

With the hydrophobic CNT surface (as observed visually by the high contact angle for water droplets on the CNT film surface), water cannot effectively wet the nanopores. This prevents hydrolysis leading to accumulation of formate in the coordination sphere, deactivating the catalyst as the format complex, 3, in FIG. 6. Presumably, the added PEG overlayer renders the CNT surface more hydrophilic and formate is rapidly released to the external solution, regenerating electroactive 2.

The non-covalent surface attachment procedure enables the CNT electrode to be readily replenished with fresh Ir catalyst for reuse. The iridium catalyst can be removed by soaking the electrode in THF leaving a clean electrode surface with essentially no electrochemical response under CO₂. Newly prepared catalyst solutions can be re-deposited by using the procedure in FIG. 2. Renewed electrodes show no significant reduction in surface coverage over five cycles of loading/deloading (FIG. 5, right). The CNT film also demonstrates excellent mechanical stability with no visible peeling after multiple catalytic cycles.

The non-covalent surface binding approach was scaled up to fabricate large area gas diffusion electrodes (GDE). A carbon fiber paper (5×5 cm) with a carbon black gas diffusion layer was dip-coated by using a CNT DMF suspension (FIG. 2, ca. 0.06 mg/cm² CNT coverage) and characterized by SEM. The cross section image shows a stacked triple-layer (FIGS. 3c and S9): a carbon fiber macroporous layer (240 μm thick), a carbon black microporous layer (50 μm), and a CNT nanoporous layer (1.2 μm). The CNT film morphology and porosity are comparable with those on FTO, but with nearly doubled thicknesses (FIG. 3c, d). The catalyst layer and PEG overlayer were sequentially applied using dip-coating (FIG. 2). XPS (not shown) showed comparable Ir:C ratios with those on FTO (not shown). Using the Ir:C ratio and the CNT coverage, the catalyst loading on the GDE was estimated to be 3.8×10⁻⁹ mol/cm² (see experimental below).

The current density from the GDE increased while retaining excellent formate selectivity. The current density of GDL/CNT/1/PEG (entry 7 in Table 1) was doubled to 6.9 mA/cm² as compared to using GC as support (3.3 mA/cm², entry 3), and was further increased to 10.2 mA/cm² by purging with CO₂ in the catholyte (entry 8). The increased current density is mainly due to increased electrode surface area and improved mass transport with CO₂ purging. The mass transport is especially relevant considering the low CO₂ concentration in water (ca. 30 mM). The triple-layered structure together with the PEG overlayer in the GDE appear to offer beneficial partitioning of hydrophobic and hydrophilic regions and thus an increase in the gas-liquid interface which facilitates CO₂ transport. As these results were obtained in a stirred solution, further increases in current density are expected in a flow device.^{[12c]} The non-covalent functionalization simplifies the integration of organometallic catalysts into GDEs and is compatible with large-scale, roll-to-roll production, providing a scalable basis for incorporating organometallic catalysts in CO₂ electrolyzers. FTO as an electro-conductive substrate was also investigated but proved to be unstable under the conditions of the electrochemical reductions due to reduction to Sn(0) and destabilization of the surface.

In summary, iridium pincer dihydride catalyst, 1, has been immobilized on carbon nanotube thin film electrodes with a convenient, scalable non-covalent approach. The interfacial Ir catalyst demonstrates excellent efficiency, selectivity and longevity for the electrochemical production of formate from CO₂. The derivatized electrode can be replenished with fresh catalyst for long-term use reducing the operational cost of periodically replacing the electrode. Optimization with a gas diffusion electrode derivatized with the Ir catalyst led to high current densities of ca. 10 mA/cm² while maintaining high formate selectivity. The integration of the Ir catalyst into a gas diffusion electrode dramatically lowers the barrier for device integration and potentially enables large-scale electrochemical production of formate from CO₂. The non-covalent approach is general, allowing a broad variety of catalysts and electrode configurations to be utilized.

### Materials and Methods

All chemicals were purchased from commercial sources if not mentioned otherwise. Acetonitrile was of HPLC grade and further purified by a Pure-Solv Solvent Purification System (Innovative Technology). Distilled water was further purified by using a Milli-Q Synthesis A10 Water Purification system. Argon was purified by passing through columns of BASF R3-11 catalyst (Chemalog) and 4 Å molecular sieves. CO₂ (National Welders, research grade) was of 99.999% purity with less than 3 ppm H₂O and used as received. Air-sensitive materials were prepared and manipulated using Schlenk techniques and in an argon-atmosphere glovebox (MBraun Unilab, <1 ppm in O₂ and H₂O). Deuterated solvents CD₂Cl₂, C₆D₆ (Cambridge Isotope) were dried with CaH₂ or 4 Å molecular sieves and vacuum transferred into Kontes flasks. D₂O (Cambridge Isotope) was used as received. Tetrabutylammonium hexafluorophospate (“Bu₄NPF₆, Fluka, electrochemical grade) was dried at 60° C. under vacuum for 12 h and stored in the glovebox. [(COE)₂IrCl]₂ was synthesized using a variation of the literature procedure (J. L. Herde, J. C. Lambert, C. V. Senoff, Inorg. Synth. 1974, 15, 18-19). Polyethylene glycol (Mw 15,000-20,000) was purchased from Aldrich. Multi-walled carbon nanotubes (>95%, 20-30 nm o.d., 110 m²/g surface area) were purchased from Cheap Tubes Inc. Freudenberg I2 C3 carbon paper (10×10 cm) with a microporous layer was purchased from FuelCellsEtc. Fluorine-doped SnO₂ (FTO, sheet resistance 15 Ω/cm²) was obtained from Hartford Glass Co., Inc. All other reagents are commercially available and were used without further purification.

NMR spectra were recorded on Bruker NMR spectrometers (AVANCE-400, AVANCE-500, and AVANCE-600). ¹H and ¹³C NMR spectra were referenced to residual solvent signals. ³¹P chemical shifts were referenced to a H₃PO₄ external standard. Due to a strong ³¹P-³¹P coupling in PCP-type ligands, some ¹H and ¹³C NMR signals appear as virtual triplets and are thus reported with apparent coupling constants. Gaseous products were analyzed using a Varian 450-GC with a molecular sieve column and a PDHID detector. High resolution mass spectrometry (HRMS) was obtained on a Thermo LTqFT mass spectrometer (Thermo Fisher Scientific) using standard a electrospray source with direct infusion at positive ion FT mode and external calibration.

Scanning electron microscopy (SEM) was carried out on a Hitachi S-4700 Cold Cathode Field Emission Scanning Electron Microscope. X-ray photoelectron spectra (XPS) were obtained using a Kratos Analytical Axis UltraDLD spectrometer with monochromatized X-ray Al Kα radiation (1486.6 eV) with an analysis area of 1 mm². A survey scan was first performed with a step size of 1 eV, a pass energy of 80 eV, and a dwell time of 200 ms. High resolution scans were then taken for each element present with a step size of 0.1 eV and a pass energy of 20 eV. The binding energy for all peaks was referenced to the C 1 s peak at 284.6 eV XRD.

Electrochemistry.

Electrochemical experiments were performed using a CHI 6012D custom-made potentiostat (CH Instruments, Inc., TX). A three-electrode setup for aqueous media consisted of a glassy carbon working electrode (BASi, 7.1 mm²), a coiled Pt wire counter electrode, and a SCE reference electrode (0.244 V vs NHE) in an airtight, glass frit-separated two-compartment cell. In non-aqueous solvents, the reference electrode was Ag/AgNO₃ reference electrode (BASi, 10 mM AgNO₃, 0.1 M ⁿBu₄NPF₆ in acetonitrile), and ferrocene was added at the end of the experiment and the potential was converted relative to NHE following a literature protocol (V. V. Pavlishchuk, A. W. Addison, Inorg. Chim. Acta 2000, 298, 97-102). Prior to each measurement, the glassy carbon electrode was polished with a 0.05-μm alumina slurry for 1 min, then sonicated and thoroughly rinsed with Milli-Q water and acetone, and finally dried in an Ar stream. In cyclic voltammetry experiments, the working and counter electrodes were separated from the reference electrode. In controlled potential electrolyses, the reference and working electrodes were separated from the Pt mesh counter electrode with a glass frit.

Controlled potential electrolyses were performed in 0.1 M NaHCO₃, 0.5 M LiClO₄, 1% v/v MeCN aqueous solutions in an airtight electrochemical cell under vigorous stirring. The solution was degassed by purging with Ar for 15 min and then saturated with 1 atm of CO₂ before sealing the cell. Solution resistance was measured and compensated at 85% level in the bulk electrolyses. At the end of electrolysis, gaseous samples (0.5 mL) were drawn from the headspace by a gas-tight syringe (Vici) and injected into the GC. Calibration curves for H₂ and CO were obtained separately. The liquid phase was doped with a known amount of DMF as internal standard and diluted 1:1 with D₂O for immediate ¹H NMR analysis. In the electrolyses which were continuously sparged with CO₂, the CO₂ stream was first humidified in a water bubbler and then passed into the catholyte, the gaseous products were not determined in this case because they were purged.

### Syntheses

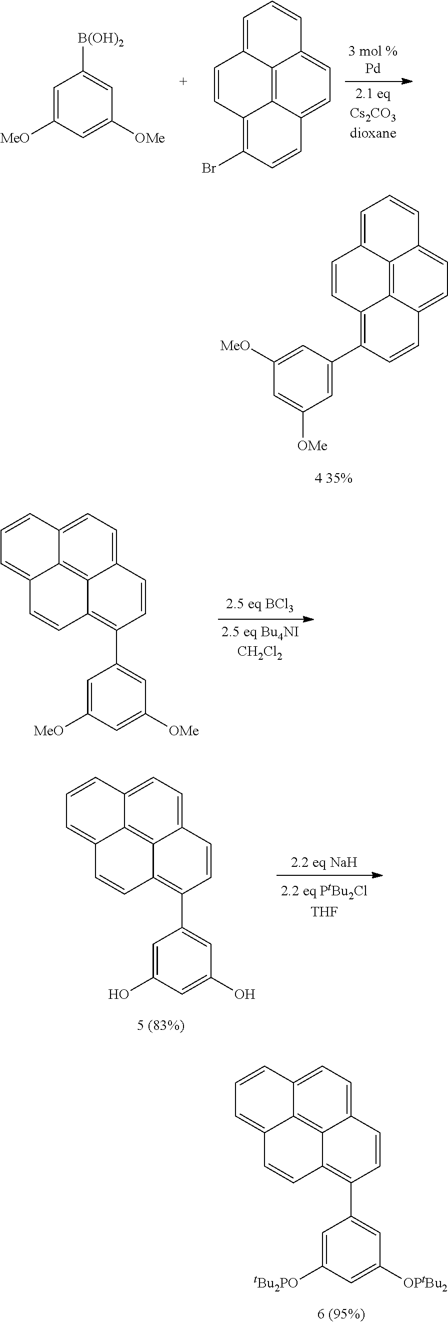

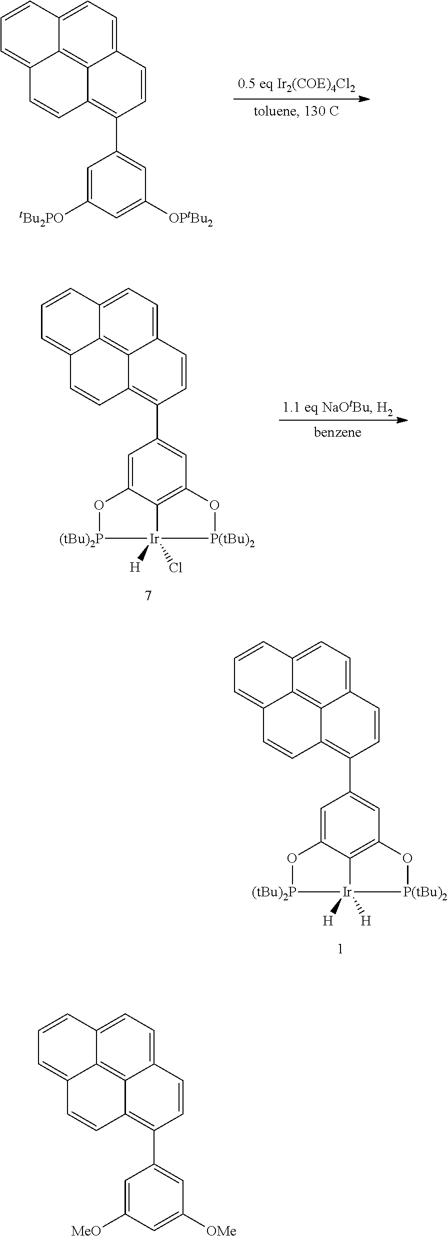

Compound 4:

A septum-capped Schlenk flask was charged with 0.65 g (3.5 mmol) of 3,5-dimethoxyphenylboronic acid, 6.5 g (20.0 mmol) of Cs₂CO₃, and 0.12 g (0.1 mmol) of Pd(PPh₃)₄ under Ar. A solution of 1.0 g (3.5 mmol) of 1-bromopyrene in 30 mL of 1,4-dioxane was then added, and the slurry was vigorously stirred for 12 h at 80° C. The resulting slurry was added to a separation funnel containing 20 mL of 0.1 M NaOH and extracted with 3×30 mL diethyl ether. The combined organic layers were dried over MgSO₄ and filtered. After removal of the solvent, the resulting solid was separated by column chromatography on silica gel (hexanes: diethyl ether 1:1, R_{f}=0.5) to give 430 mg (1.3 mmol, 36%) of 4 as a off-white crystalline solid. ¹H NMR (600 MHz, CDCl₃): δ 8.14-8.23 (m, 4H, Pyr-H), 8.08 (s, 2H, Pyr-H), 7.97-8.03 (m, 3H, Pyr-H), 6.77 (d, J=2.2 Hz, 2H, Ar—H), 6.60 (t, J=2.2 Hz, 1H, Ar—H), 3.86 (s, 1H, OMe). ¹³C{¹H} NMR (150.9 MHz, CDCl₃): δ 160.8 (C_{q}, s), 143.4 (C_{q}, s), 137.8 (C_{q}, s), 131.6 (C_{q}, s), 131.2 (C_{q}, s), 130.9 (C_{q}, s), 127.7 (CH, s, Pyr-C), 127.7 (CH, s, Pyr-C), 127.6 (CH, s, Pyr-C), 127.5 (CH, s, Pyr-C), 126.2 (CH, s, Pyr-C), 125.5 (CH, s, Pyr-C), 125.3 (CH, s, Pyr-C), 125.1 (CH, s, Pyr-C), 124.7 (CH, s, Pyr-C), 109.0 (CH, s, Ar—C4 and C6), 99.6 (CH, s, Ar—C2), 55.7 (CH, s, OMe). HR-MS ESI+ (80:20 v/v % MeOH:H₂O, 0.2% formic acid): calculated 339.1385 (M+H⁺); found 339.1389.

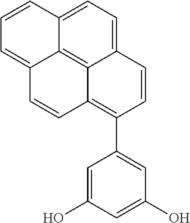 [SMILES: Oc1cc(O)cc(-c2ccc3ccc4cccc5ccc2c3c45)c1]

Compound 5:

The synthesis followed a modification of a literature procedure (P. R. Brooks, M. C. Wirtz, M. G. Vetelino, D. M. Rescek, G. F. Woodworth, B. P. Morgan, J. W. Coe, J Org Chem 1999, 64, 9719-9721). A dichloromethane solution of boron trichloride (1.5 mL, 1.0 M, 1.5 mmol) was added to a 35 mL dichloromethane solution of 202 mg (0.6 mmol) of 4 and 550 mg (1.5 mmol) of tetrabutylammonium iodide at −78° C. and the solution was stirred for 2 h under Ar. The solution was then warmed to RT and stirred for 12 h. Water (30 mL) was added, and the biphasic solution was vigorously stirred for 30 min.

Dichloromethane was evaporated using a rotovap, and 100 mL of diethyl ether was added to the residue. The organic layer was washed with 4×30 mL of 1 M HCl (separated and discarded), then with 20 mL of 0.5 M NaOH and separated from the organic phase. The aqueous phase was treated dropwise with 10 mL of 3 M HCl. A white solid precipitated and was then extracted into 4×20 mL of diethyl ether. Removal of the solvent under reduced pressure yielded 155 mg (0.5 mmol, 83%) of a white powder, which was NMR-pure and used without further purification. ¹H NMR (600 MHz, CD₃OD): δ 8.17 (d, J=9.3 Hz, 1H, Pyr-H), 8.02 (d, J=7.8 Hz, 1H, Pyr-H), 7.97 (t, J=6.9 Hz, 2H, Pyr-H), 7.80-7.88 (m, 5H, Pyr-H), 8.08 (s, 2H, Pyr-H), 7.97-8.03 (m, 3H, Pyr-H), 6.61 (d, J=2.2 Hz, 2H, Ar—H4 and H6), 6.52 (t, J=2.2 Hz, 1H, Ar—H2). ¹³C{¹H} NMR (150.9 MHz, CD₃OD): δ159.6 (C_{q}, s), 144.7 (C_{q}, s), 139.2 (C_{q}, s), 132.7 (C_{q}, s), 132.3 (C_{q}, s), 131.8 (C_{q}, s), 129.5 (C_{q}, s), 128.3 (CH, s, Pyr-C), 128.3 (CH, s, Pyr-C), 128.3 (CH, s, Pyr-C), 128.2 (CH, s, Pyr-C), 127.1 (CH, s, Pyr-C), 126.3 (CH, s, Pyr-C), 126.1 (CH, s, Pyr-C), 126.0 (C_{q}, s), 125.9 (C_{q}, s), 125.8 (CH, s, Pyr-C), 125.6 (CH, s, Pyr-C), 110.5 (CH, s, Ar—C4 and C6), 102.7 (CH, s, Ar—C2). HR-MS ESI+ (80:20 v/v % MeOH:H₂O, 0.2% formic acid): calculated 311.1072 (M+H⁺); found 311.1075.

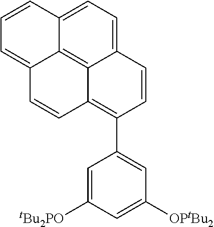

Compound 6:

NaH (1.0 mmol, 24 mg) was added to a solution of 5 (0.5 mmol, 155 mg) in 20 mL THF (caution: hydrogen evolution). The mixture was heated to reflux for 1 h, and di-tert-butylchlorophosphine (1.0 mmol, 180 mg) in THF solution (5 mL) was added using a syringe, and refluxed for additional 1 h. After removing the solvent under high vacuum, the residue was extracted with 50 mL pentane, and filtered through Celite. Upon removal of solvent from the filtrate under vacuum, the residue was kept under high vacuum at 55° C. for 2 h. The product 6 (284 mg, 0.48 mmol, 95%) was an off-white pellet with high NMR purity, and used for further reactions without purification. ¹H NMR (600 MHz, C₆D₆): δ 8.49 (d, J=9.3 Hz, 1H, Pyr-H), 7.98 (d, J=7.9 Hz, 1H, Pyr-H), 7.85-7.95 (m, 3H, Pyr-H), 7.83 (s, 1H, Pyr-H), 7.84 (s, 1H, Pyr-H), 7.77 (d, J=4.4 Hz, 1H, Pyr-H), 7.75 (d, J=2.8 Hz, 1H, Pyr-H), 7.70 (m, 1H, Ar—H), 7.45 (m, 2H, Ar—H), 1.17 (d, J_{P—H}=11.7 Hz, 36H, C(CH₃)₃). ³¹P{¹H} NMR (162.0 MHz, C₆D₆): δ153.7.

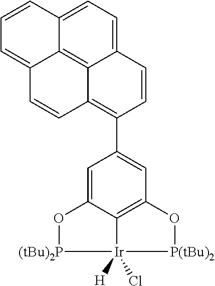

Complex 7: To an Ar-filled Schlenk flask was added 0.5 equivalent of [(COE)₂IrCl]₂ (0.1 mmol, 90 mg, COE=cycloctene) and 1 equivalent of 6 (0.2 mmol, 120 mg) in 15 mL toluene. The solution was refluxed at 130° C. for 12 h and then cooled to room temperature. The solvent was removed in vacuum, and the residue was extracted with 30 mL pentane. After filtration and solvent removal, the resulting solid was dried under high vacuum to yield highly pure product (NMR). Yield: 159 mg, 96%. ¹H NMR (600 MHz, CD₂Cl₂): δ 8.41 (d, J=9.2 Hz, 1H, Pyr-H), 8.17-8.24 (m, 3H, Pyr-H), 8.11 (s, 1H, Pyr-H), 8.10 (s, 1H, Pyr-H), 8.00-8.09 (m, 3H, Pyr-H), 6.87 (s, 2H, Ar—H), 1.30 (m, 36H, C(CH₃)₃), −41.1 (t, J_{P—H}=13.0 Hz, 1H, Ir-H). ¹³C{¹H} NMR (151 MHz, CD₂Cl₂): δ 168.3 (C_{q}, t, J_{P—C}=6.2 Hz, Ar—C), 139.2 (C_{q}, s, Pyr-C), 138.7 (C_{q}, s, Pyr-C), 132.1 (C_{q}, s, Pyr-C), 131.6 (C_{q}, s, Pyr-C), 130.8 (C_{q}, s, Pyr-C), 128.8 (CH, s, Pyr-C), 128.2 (CH, s, Pyr-C), 128.0 (CH, s, Pyr-C), 127.8 (CH, s, Pyr-C), 127.7 (CH, s, Pyr-C), 126.5 (CH, s, Pyr-C), 126.1 (CH, s, Pyr-C), 125.6 (C_{q}, s, Pyr-C), 125.5 (CH, s, Pyr-C), 125.4 (C_{q}, s, Pyr-C), 125.2 (CH, s, Pyr-C), 107.8 (CH, t, J_{P—C}=5.4 Hz, Ar—C3 and C5), 43.7 (C_{q}, t, J_{P—C}=11.1 Hz, ^{t}Bu-C), 40.1 (C_{q}, t, J_{P—C}=11.1 Hz, ^{t}Bu-C), 28.1 (CH₃, t, J_{P—C}=3.3 Hz, ^{t}Bu-CH₃), 27.8 (CH₃, t, J_{P—C}=3.3 Hz, ^{t}Bu-CH₃). ³¹P{¹H} NMR (243 MHz, CD₂Cl₂): δ176.3. HR-MS ESI+ (MeCN): calculated 833.3024 ([M+MeCN—Cl]⁺); found 833.3047.

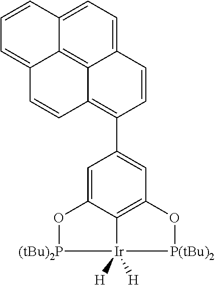

Complex 1:

To a benzene solution (15 mL) of 7 (0.1 mmol, 83 mg) was added NaO^{t}Bu (0.11 mmol, 10.6 mg). The solution was stirred under a stream of H₂ for 1 h at RT. The reaction mixture was then cooled to 0° C., and the frozen solvent was removed in vacuo. The residue was taken up in 20 mL pentane under Ar and filtered through a syringe filter. The solvent was removed in vacuo, and the residue was dissolved in 5 mL benzene, and was frozen and dried at 0° C. to yield a brown powder (75 mg, 95%). ¹H NMR (600 MHz, C₆D₆): δ 8.61 (d, J=9.2 Hz, 1H, Pyr-H), 7.98 (d, J=7.7 Hz, 1H, Pyr-H), 7.93 (d, J=7.7 Hz, 1H, Pyr-H), 7.88 (d, J=8.0 Hz, 1H, Pyr-H), 7.83 (m, 3H, Pyr-H), 7.73 (d, J=7.7 Hz, 1H, Pyr-H), 7.63 (d, J=9.2 Hz, 1H, Pyr-H), 7.34 (s, 2H, Ar—H), 1.36 (t, J_{P—H}=7.2 Hz, 36H, C(CH₃)₃), −16.63 (t, J_{P—H}=8.1 Hz, 2H, Ir—H). ¹³C{¹H} NMR (151 MHz, C₆D₆): δ 170.9 (C_{q}, t, J_{P—C}=7.1 Hz, Ar—C), 154.5 (C_{q}, t, J_{P—C}=6.3 Hz, Ar—C), 145.6 (C_{q}, s, Pyr-C), 139.4 (C_{q}, s, Pyr-C), 138.9 (C_{q}, s, Pyr-C), 132.4 (C_{q}, s, Pyr-C), 132.0 (C_{q}, s, Pyr-C), 131.3 (C_{q}, s, Pyr-C), 129.4 (C_{q}, s, Pyr-C), 128.1 (CH, s, Pyr-C), 128.0 (CH, s, Pyr-C), 127.9 (CH, s, Pyr-C), 127.8 (CH, s, Pyr-C), 126.6 (CH, s, Pyr-C), 126.4 (CH, s, Pyr-C), 126.1 (C_{q}, s, Pyr-C), 126.0 (C_{q}, s, Pyr-C), 125.5 (CH, s, Pyr-C), 125.4 (CH, s, Pyr-C), 125.3 (CH, s, Pyr-C), 107.1 (CH, t, J_{P—C}=5.7 Hz, Ar—C3 and C5), 40.6 (C_{q}, t, J_{P—C}=11.8 Hz, ^{t}Bu-C), 29.2 (CH₃, t, J_{P—C}=3.3 Hz, ^{t}Bu-CH₃). ³¹P{¹H} NMR (243 MHz, C₆D₆): δ 205.2.

Preparation of Carbon Nanotube Thin Films.

Multiwalled carbon nanotubes (CNT, 5 mg) were added to 5 mL DMF and sonicated in an ultrasonic cleaner (Fischer Scientific) for 30 min to yield a homogeneous CNT suspension (1 mg/mL) with no visible precipitates at the bottom. The suspension was stable for 12 hours with no significant aggregation of CNTs. The glassy carbon and FTO electrodes were rinsed with ethanol and dried under a stream of N₂. The CNT DMF suspension (10 μl) was dropped on top of the glassy carbon electrode or FTO using a pipette and dried under ambient conditions.

For coating the GDL substrate, a 5×5 cm GDL was submerged into a CNT DMF suspension (5 mL, CNT 1 mg/mL) in a culture dish for 1 min with gentle agitation. It was dried under vacuum for 4 h. The surface coverage of CNT on GDL was estimated using the weight of CNT deposited.

Immobilization of Ir Pincer Catalyst 1.

In a drybox, 10 μl of MeCN solution of 1 (0.2 mM) was added to the CNT coated GC or FTO electrode and dried at RT. When the GDL was used, it was dipped into the MeCN solution of 1 (0.2 mM) for 1 min and dried at RT. The electrodes were then dipped into clean MeCN for 30 seconds with gentle agitation and finally dried at RT. The catalyst-loaded electrodes were stored under Ar.

Application of the PEG Overlayer.

In an N₂-atmosphere wetbox (Vacuum Atmospheres Company, Dri-Lab, <5 ppm O₂), 10 μl degassed PEG aqueous solution (0.01% w/w) was added on top of the GC or FTO electrodes that were pre-loaded with CNT film and 1 and dried at RT; the GDL/CNT/1 (5×5 cm) electrode was dipped into the PEG solution for 15 seconds and allowed to dry under vacuum for 1 h. The PEG coated electrodes were stored under Ar before use.

Electrode Assembly.

The GC/CNT/1/PEG electrode was used as is. FTO or GDL based electrodes were cut into 0.5×2.5 cm strips. Ohmic contact was made to FTO or GDL using a Cu foil, and Kapton tape (Fisher Scientific) was applied to mask the copper foil and the electrode to expose ca. 0.5×1 cm electrode area. The Cu foil was connected to the working electrode and was never submerged into the solution.

### REFERENCES

[1] Climate Change: Evidence, Impacts, and Choices: Set of 3 Booklets, The National Academies Press, 2012.
[2] T. C. Johnson, D. J. Morris, M. Wills, Chem. Soc. Rev. 2010, 39, 81-88.
[3] C. A. Huff, M. S. Sanford, J. Am. Chem. Soc. 2011, 133, 18122-18125.
[4] R. Noyori, S. Hashiguchi, Acc. Chem. Res. 1997, 30, 97-102.
[5] C. Rice, R. I. Ha, R. I. Masel, P. Waszczuk, A. Wieckowski, T. Barnard, J. Power Sources 2002, 111, 83-89.
[6] a) W. Reutemann, H. Kieczka, in Ullmann's Encyclopedia of Industrial Chemistry, Wiley-VCH Verlag GmbH & Co. KGaA, 2000; b) A. J. S. Pollard, D. S. Banasiak, C. J. Ellens, J. N. Brown, Avello Bioenergy, Inc., United States Patent Application 20120302470, 2012.
[7] H. Li, P. H. Opgenorth, D. G. Wernick, S. Rogers, T. Y. Wu, W. Higashide, P. Malati, Y. X. Huo, K. M. Cho, J. C. Liao, Science 2012, 335, 1596-1596.
[8] A. S. Agarwal, Y. M. Zhai, D. Hill, N. Sridhar, Chemsuschem 2011, 4, 1301-1310.
[9] a) E. E. Benson, C. P. Kubiak, A. J. Sathrum, J. M. Smieja, Chem. Soc. Rev. 2009, 38, 89-99; b) M. Cokoja, C. Bruckmeier, B. Rieger, W. A. Herrmann, F. E. Kuhn, Angew. Chem., Int. Ed. 2011, 50, 8510-8537; c) C. Finn, S. Schnittger, L. J. Yellowlees, J. B. Love, Chem. Commun. 2012, 48, 1392-1399; d) A. M. Appel, J. E. Bercaw, A. B. Bocarsly, H. Dobbek, D. L. DuBois, M. Dupuis, J. G. Ferry, E. Fujita, R. Hille, P. J. A. Kenis, C. A. Kerfeld, R. H. Morris, C. H. F. Peden, A. R. Portis, S. W. Ragsdale, T. B. Rauchfuss, J. N. H. Reek, L. C. Seefeldt, R. K. Thauer, G. L. Waldrop, Chem. Rev. 2013, 113, 6621-6658; e) C. Costentin, M. Robert, J.-M. Saveant, Chem. Soc. Rev. 2013, 2013, 2423-2436; f) P. Kang, Z. Chen, M. Brookhart, T. J. Meyer, Top. Catal. 2013, submitted.
[10] a) H. Ishida, H. Tanaka, K. Tanaka, T. Tanaka, J. Chem. Soc., Chem. Commun 1987, 131-132; b) C. Arana, S. Yan, M. Keshavarzk, K. T. Potts, H. D. Abruna, Inorg. Chem. 1992, 31, 3680-3682; c) C. Caix, S. Chardon-Noblat, A. Deronzier, J. Electroanal. Chem. 1997, 434, 163-170; d) P. Kang, C. Cheng, Z. F. Chen, C. K. Schauer, T. J. Meyer, M. Brookhart, J. Am. Chem. Soc. 2012, 134, 5500-5503; e) P. Kang, T. J. Meyer, M, Brookhart, Chem. Sci. 2013, 4, 3497-3502.
[11] a) J. Hawecker, J. M. Lehn, R. Ziessel, J. Chem. Soc., Chem. Commun 1984, 328-330; b) M. Beley, J. P. Collin, R. Ruppert, J. P. Sauvage, J. Chem. Soc., Chem. Commun 1984, 1315-1316; c) J. M. Smieja, C. P. Kubiak, Inorg. Chem. 2010, 49, 9283-9289; d) M. Bourrez, F. Molton, S. Chardon-Noblat, A. Deronzier, Angew. Chem., Int. Ed. 2011, 50, 9903-9906; e) Z. F. Chen, C. C. Chen, D. R. Weinberg, P. Kang, J. J. Concepcion, D. P. Harrison, M. S. Brookhart, T. J. Meyer, Chem. Commun. 2011, 47, 12607-12609; f) C. Costentin, S. Drouet, M. Robert, J.-M. Saveant, Science 2012, 338, 90-94; g) V. S. Thoi, N. Kornienko, C. G. Margarit, P. Yang, C. J. Chang, J. Am. Chem. Soc. 2013, 135, 14413-14424.
[12] a) Y. Hori, H. Wakebe, T. Tsukamoto, O. Koga, Electrochim. Acta 1994, 39, 1833-1839; b) Y. H. Chen, M. W. Kanan, J. Am. Chem. Soc. 2012, 134, 1986-1989; c) C. Delacourt, P. L. Ridgway, J. B. Kerr, J. Newman, J. Electrochem. Soc. 2008, 155, B42-B49; d) B. A. Rosen, A. Salehi-Khojin, M. R. Thorson, W. Zhu, D. T. Whipple, P. J. A. Kenis, R. I. Masel, Science 2011, 334, 643-644.
[13] a) S. Chardon-Noblat, A, Deronzier, R. Ziessel, D. Zsoldos, J. Electroanal. Chem. 1998, 444, 253-260; b) S. A. Yao, R. E. Ruther, L. Zhang, R. A. Franking, R. J. Hamers, J. F. Berry, J. Am. Chem. Soc. 2012, 134, 15632-15635.
[14] a) R. Borup, J. Meyers, B. Pivovar, Y. S. Kim, R. Mukundan, N. Garland, D. Myers, M. Wilson, F. Garzon, D. Wood, P. Zelenay, K. More, K. Stroh, T. Zawodzinski, J. Boncella, J. E. McGrath, M. Inaba, K. Miyatake, M. Hori, K. Ota, Z. Ogumi, S. Miyata, A. Nishikata, Z. Siroma, Y. Uchimoto, K. Yasuda, K. I. Kimijima, N. Iwashita, Chem. Rev. 2007, 107, 3904-3951; b) L. Cindrella, A. M. Kannan, J. F. Lin, K. Saminathan, Y. Ho, C. W. Lin, J. Wertz, J. Power Sources 2009, 194, 146-160.
[15] H. R. Jhong, F. R. Brushett, P. J. A. Kenis, Adv Energy Mater 2013, 3, 589-599.
[16] a) D. Tasis, N. Tagmatarchis, A. Bianco, M. Prato, Chem. Rev. 2006, 106, 1105-1136; b) C. C. L. McCrory, A. Devadoss, X. Ottenwaelder, R. D. Lowe, T. D. P. Stack, C. E. D. Chidsey, J. Am. Chem. Soc. 2011, 133, 3696-3699; c) E. C. Landis, R. J. Hamers, Chem. Mat. 2009, 21, 724-730; d) M. V. Sheridan, K. Lam, W. E. Geiger, J. Am. Chem. Soc. 2013, 135, 2939-2942.
[17] F. Li, B. B. Zhang, X. N. Li, Y. Jiang, L. Chen, Y. Q. Li, L. C. Sun, Angew. Chem., Int. Ed. 2011, 50, 12276-12279.
[18] P. D. Tran, A. Le Goff, J. Heidkamp, B. Jousselme, N. Guillet, S. Palacin, H. Dau, M. Fontecave, V. Artero, Angew. Chem., Int. Ed. 2011, 50, 1371-1374.
[19] J. D. Blakemore, A. Gupta, J. J. Warren, B. S. Brunschwig, H. B. Gray, J. Am. Chem. Soc. 2013, ASAP.
[20] J. A. Mann, J. Rodriguez-Lopez, H. D. Abruna, W. R. Dichtel, J. Am. Chem. Soc. 2011, 133, 17614-17617.

The foregoing is illustrative of the present invention, and is not to be construed as limiting thereof. The invention is defined by the following claims, with equivalents of the claims to be included therein.

That which is claimed is:

1. A catalytic compound of Formula (I):) or Formula (II): 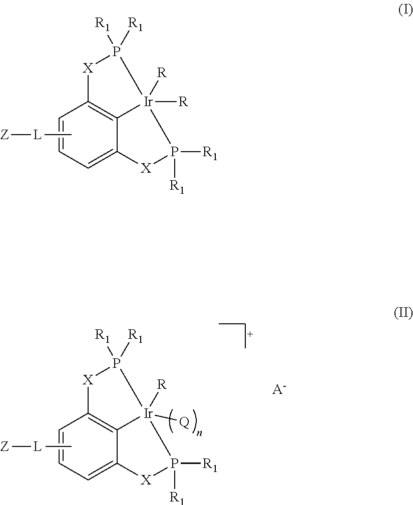
wherein:
each R is independently H or a C₁-C₃₀ hydrocarbyl radical;
each R₁ is independently a C₁-C₃₀ hydrocarbyl radical;
each X is independently selected from 0 and CH₂;
L is a covalent bond or linking group;
Z is an at least one planar pi-bond containing organic group;
each Q is a neutral two-electron donor ligand;
n is 1 or 2; and
A⁻ is a non-coordinating counter-anion.

2. The compound of claim 1, wherein said planar organic group comprises a polycyclic aromatic group.

3. The compound of claim 2, wherein said polycyclic aromatic group comprises pyrene, anthracene, pentacene, benzo[a]pyrene, chrysene, coronene, corannulene, naphthacene, phenanthrene, triphenylene, ovalene, benzophenanthrene, perylene, benzo[ghi]perylene, antanthrene, pentaphene, picene, dibenzo[3,4;9,10]pyrene, benzo[3,4]pyrene, dibenzo[3,4;8,9]pyrene, dibenzo[3,4;6,7]pyrene, dibenzo[1,2;3,4]pyrene, naphtho[2,3;3,4]pyrene, or any combination thereof.

4. The compound of claim 2, wherein said polycyclic aromatic group optionally contains at least one heteroatom selected from the group consisting of O, S, N, P, B, Si, and combinations thereof.

5. The compound of claim 2, wherein said polycyclic aromatic group comprises a graphene sheet.

6. The compound of claim 1, where each R is H.

7. The compound of claim 1, wherein said compound has the structure of Formula I.

8. The compound of claim 1, wherein said compound has the structure of Formula II.

9. A method of making or regenerating a catalytic electrode useful for the production of formate from carbon dioxide, comprising:
(a) providing a gas diffusion electrode having a electrolyte contact surface, carbon nanoparticles on said electrolyte contact surface, and optionally a polyalkylene oxide coating on said carbon nanotubes;
(b) contacting to said carbon nanoparticles a polar organic solvent having a catalytic compound of claim 1 therein under conditions in which said catalytic compound conjugates to said nanotubes; and
(c) optionally coating or recoating said nanotubes with an organic polymer before or after said contacting step.

10. The method of claim 9, wherein said polar organic solvent comprises a nitrile solvent.

11. The method of claim 9, wherein:
said carbon nanoparticles are comprised of an sp2-carbon containing material; and/or
said organic polymer comprises a hydrophilic or amphiphilic, neutrally charged, organic polymer.

12. A catalytic electrode useful for the production of formate from carbon dioxide, comprising:
(a) an electrode substrate having a electrolyte contact surface;
(b) carbon nanoparticles on said electrolyte contact surface;
(c) a compound of claim 1 coupled to said carbon nanotubes; and
(d) an organic polymer coating on said carbon nanotubes.

13. The catalytic electrode of claim 12, wherein said electrode substrate comprises a porous carbon gas diffusion electrode.

14. The electrode of claim 12, wherein said carbon nanoparticles are comprised of an sp2-carbon containing material.

15. The electrode of claim 12, wherein said polymer coating comprises a hydrophilic or amphiphilic, preferably neutrally charged, organic polymer.

16. The electrode of claim 12, wherein:
said carbon nanoparticles are deposited on the electrode substrate to a thickness of 0.1 micrometers to 200 micrometers; and/or
said polymer coating is loaded on the carbon nanotube layer to a weight of 0.001 milligrams per square centimeter up to 20 milligrams per square centimeter.

17. A method of making formate from carbon dioxide, comprising:
providing a catalytic electrode of claim 12; and
contacting said electrode to water and carbon dioxide while passing a current through said electrode sufficient to reduce said carbon dioxide to formate.
